(19) United States
(12) Patent Application Publication
(10) Pub. No.: US 2022/0199313 A1
(43) Pub. Date: Jun. 23, 2022

(54) COIL COMPONENT

(71) Applicant: SAMSUNG ELECTRO-MECHANICS CO., LTD., Suwon-si (KR)

(72) Inventors: Il Jin PARK, Suwon-si (KR); Joong Won PARK, Suwon-si (KR); Jong Ok JEON, Suwon-si (KR); Ji Hwan SHIN, Suwon-si (KR)

(21) Appl. No.: 17/222,613

(22) Filed: Apr. 5, 2021

(30) Foreign Application Priority Data
Dec. 23, 2020 (KR) 10-2020-0181647

(51) Int. Cl. H01F 27/255; H01F 27/29

(52) U.S. Cl. CPC H01F 27/255; H01F 27/29

(57) ABSTRACT

A coil component includes a winding coil, a body including a core portion covering the winding coil and an upper cover part and a lower cover part respectively disposed on one surface and the other surface of the core portion facing each other, and first and second external electrodes separately disposed on the body and connected to both ends of the winding coil, wherein the body includes an insulating resin and first and second metal magnetic particles having different diameters, and at least one of the core portion, the upper cover part, and the lower cover part includes only the second metal magnetic particle having a smaller diameter, among the first and second metal magnetic particles, as the magnetic particle dispersed in the insulating resin.

### CROSS-REFERENCE TO RELATED APPLICATION

This application claims benefit of priority to Korean Patent Application No. 10-2020-0181647 filed on Dec. 23, 2020 in the Korean Intellectual Property Office, the disclosure of which is incorporated herein by reference in its entirety.

### BACKGROUND

### 1. Field

The present disclosure relates to a coil component.

### 2. Description of Related Art

Coil components may include, for example, a winding coil component using magnetic particles and a winding coil. In the case of such a winding type coil component, a winding coil formed by winding a metal wire with a coating layer formed on a surface thereof in a coil shape is used as a coil of a component.

### SUMMARY

An aspect of the present disclosure may provide a winding type coil component having improved inductance and quality (Q) factor.

According to an aspect of the present disclosure, a coil component may include: a winding coil; a body including a core portion covering the winding coil and an upper cover part and a lower cover part respectively disposed on one surface and the other surface of the core portion facing each other; and first and second external electrodes separately disposed on the body and connected to both ends of the winding coil, wherein the body includes an insulating resin and first and second metal magnetic particles having different diameters, and at least one of the core portion, the upper cover part, and the lower cover part includes only the second metal magnetic particle having a smaller diameter, among the first and second metal magnetic particles, as the magnetic particle dispersed in the insulating resin.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view schematically illustrating a coil component according to an exemplary embodiment in the present disclosure;

FIG. 2 is a cross-sectional view taken along line I-I′ of FIG. 1;

FIG. 3 is an enlarged view of each of A and D of FIG. 2;

FIG. 4 is an enlarged view of each of B and C of FIG. 2;

FIG. 5 is a view schematically showing a coil component according to another exemplary embodiment in the present disclosure, corresponding to FIG. 2;

FIG. 6 is an enlarged view of each of E and H of FIG. 5; and

FIG. 7 is an enlarged view of each of F and G of FIG. 5.

### DETAILED DESCRIPTION

Exemplary embodiments of the present disclosure will now be described in detail with reference to the accompanying drawings.

In the drawings, an L direction may be defined as a first direction or a length direction, a W direction may be defined as a second direction or a width direction, and a T direction may be defined as a third direction or a thickness direction.

Hereinafter, a coil component according to an exemplary embodiment in the present disclosure will be described in detail with reference to the accompanying drawings, and in the description with reference to the accompanying drawings, the same or corresponding components are given the same reference numbers, and overlapping descriptions thereof will be omitted.

Various types of electronic components are used in electronic devices, and various types of coil components may be appropriately used between the electronic components for the purpose of removing noise.

That is, in an electronic device, a coil component may be used as a power inductor, a high frequency (HF) inductor, a general bead, a high frequency bead (GHz bead), a common mode filter, and the like.

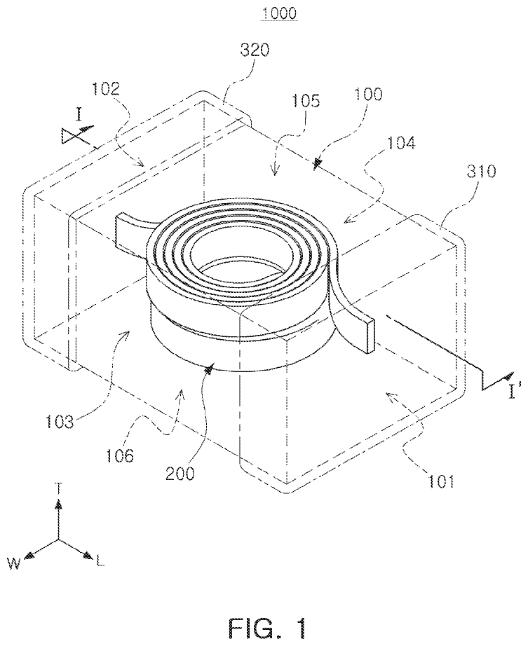

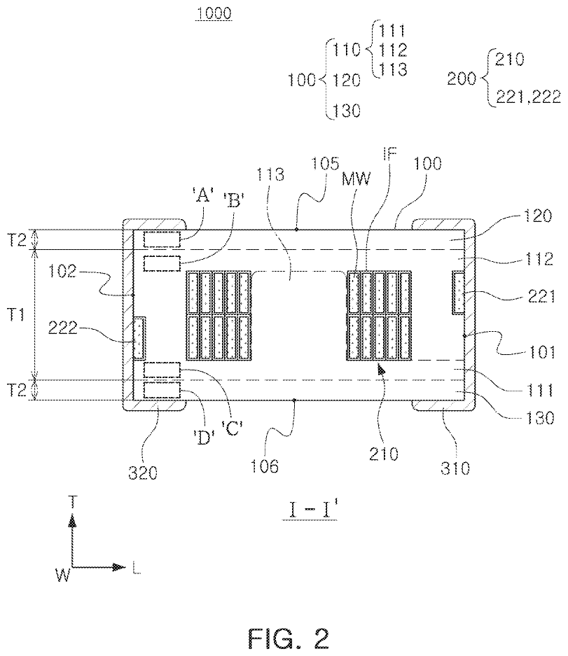

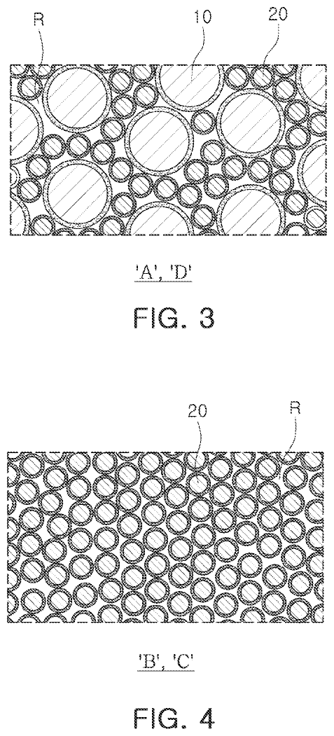

FIG. 1 is a perspective view schematically showing a coil component according to an exemplary embodiment in the present disclosure. FIG. 2 is a cross-sectional view taken along line I-I′ of FIG. 1. FIG. 3 is an enlarged view of each of A and D of FIG. 2. FIG. 4 is an enlarged view of each of B and C of FIG. 2.

Referring to FIGS. 1 to 4, a coil component 1000 according to an exemplary embodiment in the present disclosure includes a body 100, a winding coil 200, and external electrodes 310 and 320.

The body 100 forms an exterior of the coil component 1000 according to the present exemplary embodiment and includes a winding coil 200 embedded therein.

The body 100 may be formed in the shape of a hexahedron as a whole.

In FIG. 1, the body 100 includes a first surface 101 and a second surface 102 facing each other in a length direction L, a third surface 103 and a fourth surface 104 facing each other in the width direction W, and a fifth surface 105 and a sixth surface 106 facing each other in the thickness direction T. Each of the first to fourth surfaces 101, 102, 103, and 104 of the body 100 is a wall surface of the body 100 that connects the fifth surface 105 and the sixth surface 106 of the body 100. Hereinafter, both end surfaces of the body 100 may refer to the first surface 101 and the second surface 102 of the body 100, both side surfaces of the body 100 may refer to the third surface 103 and the fourth surface 104 of the body 100, and one surface and the other surface of the body 100 may refer to the sixth surface 106 and the fifth surface 105 of the body 100, respectively.

Byway of example, the body 100 may be formed such that the coil component 1000 according to the present exemplary embodiment including external electrodes 310 and 320 to be described later has a length of 2.0 mm, a width of 1.2 mm, and a thickness of 0.65 mm, but is not limited thereto. Meanwhile, the aforementioned dimensions are merely design values that do not reflect process errors, etc., and thus, it should be appreciated that dimensions within a range admitted as a processor error fall within the scope of the present disclosure.

Based on an optical microscope or a scanning electron microscope (SEM) image for a length directional (L)-thickness directional (T) cross-section at a width-directional (W) central portion of the coil component 1000, the length of the coil component 1000 may refer to a maximum value among lengths of a plurality of segments parallel to the length direction L when outermost boundary lines of the coil component 1000 illustrated in the image of the cross-section are connected. Alternatively, the length of the coil component 1000 described above may refer to an arithmetic mean value of at least two of the plurality of segments parallel in the length direction L when the outermost boundary lines of the coil component 1000 illustrated in the cross-sectional image are connected.

Based on the optical microscope or SEM image for the length directional (L)-thickness directional (T) cross-section at the width-directional (W) central portion of the coil component 1000, the thickness of the coil component 1000 may refer to a maximum value among lengths of a plurality of segments parallel to the thickness direction T when outermost boundary lines of the coil component 1000 illustrated in the image of the cross-section are connected. Alternatively, the thickness of the coil component 1000 described above may refer to an arithmetic mean value of at least two of the plurality of segments parallel in the thickness direction T when the outermost boundary lines of the coil component 1000 illustrated in the cross-sectional image are connected.

Based on an optical microscope or SEM image for a length directional (L)-width directional (W) cross-section at a thickness-directional (T)-central portion of the coil component 1000, the width of the coil component 1000 may refer to a maximum value among lengths of a plurality of segments parallel to the width direction W when outermost boundary lines of the coil component 1000 illustrated in the image of the cross-section are connected. Alternatively, the width of the coil component 1000 described above may refer to an arithmetic mean value of at least two of the plurality of segments parallel in the width direction W when the outermost boundary lines of the coil component 1000 illustrated in the cross-sectional image are connected.

Alternatively, each of the length, width, and thickness of the coil component 1000 may be measured by a micrometer measurement method. With the micrometer measurement method, each of the length, width, and thickness of the coil component 1000 may be measured by setting a zero point with a gage repeatability and reproducibility (R&R) micrometer, inserting the coil component 1000 according to the present exemplary embodiment into a tip of the micrometer, and turning a measurement lever of the micrometer. In measuring the length of the coil component 1000 by the micrometer measurement method, the length of the coil component 1000 may refer to a value measured once or an arithmetic mean of values measured multiple times. This may equally be applied to the width and thickness of the coil component 1000.

The body 100 includes a core portion 110 surrounding a winding coil 200 to be described later and an upper cover part 120 and a lower cover part 130 respectively disposed on one surface and the other surface of the core portion 110 facing each other. Specifically, referring to FIG. 2, the core portion 110 includes a lower core 111 disposed below the winding coil 200 and disposed between the winding coil 200 and the lower cover part 130, an upper core 112 disposed above the winding coil 200 and disposed between the winding coil 200 and the upper cover part 120, and a through core 113 disposed at a central portion of the winding coil 200. Based on the direction of FIG. 2, the upper cover part 120 and the lower cover part 130 may be disposed on upper and lower surfaces of the core portion 110 and may be spaced apart from the winding coil 200. The core portion 110 covers all surfaces of the winding coil 200 excluding exposed surfaces of lead portions 221 and 222 (to be described later) of the winding coil 200.

A side surface the core portion 110, together with side surfaces of the upper cover part 120 and the lower cover part 130, configure the first to fourth surfaces 101, 102, 103, and 104 of the body 100. An upper surface of the upper cover part 120 configures the fifth surface 105 of the body 100. A lower surface of the lower cover part 130 configures a sixth surface 106 of the body 100. For the above reasons, hereinafter, the sixth surface 106 of the body 100 and a lower surface of the lower cover part 130 are used as having the same meaning, and the fifth surface 105 of the body 100 and an upper surface of the upper cover part 120 are used as having the same meaning.

The lower core 111 has one side surface and the other side surface facing each other. The lower core 111 supports a winding coil 200, which will be described later, disposed on one surface of the lower core 111. A through core 113 is disposed to protrude from one surface of the lower core 111 at a central portion of one surface of the lower core 111. The lower core 111 and the through core 113 may be formed together in the same process and integrated with each other. Accordingly, the lower core 111 and the through core 113 may not have a boundary formed therebetween. For example, the lower core 111 and the through core 113 may be formed by filling a mold having an inverted T-shaped cavity with an insulating resin R and first and second metal magnetic particles 10 and 20, which will be described later, and pressing and heating the mold. The lower core 111 and the through core 113 may be a T-core. However, the scope of the present disclosure is not limited thereto.

The upper core 112 covers the winding coil 200 together with the lower core 111 and the through core 113. The upper core 112 may be formed by disposing the T-core including the lower core 111 and the through core 113, disposing the winding coil 200 at the T-core, filling the mold with an insulating resin R and first and second metal magnetic particles 10 and 20, respectively, and pressing and heating the mold. As a result, the upper core 112 forms a boundary with each of the lower core 111 and the through core 113.

The body 100 includes an insulating resin R and first and second magnetic particles 10 and 20 dispersed in the insulating resin R. The magnetic particles include a first metal magnetic particle 10 and a second metal magnetic particle 20 having a diameter smaller than a diameter of the first metal magnetic particle. Meanwhile, in the present disclosure, the diameters of the metal magnetic particles 10 and 20 are different each other may mean that average diameters thereof are different. Further, that the average diameters of the metal magnetic particles 10 and 20 are different may mean that particle size distribution values expressed by D50 or D90 are different.

The metal magnetic particles 10 and 20 may include at least any one selected from the group consisting of iron (Fe), silicon (Si), chromium (Cr), cobalt (Co), molybdenum (Mo), aluminum (Al), niobium (Nb), copper (Cu) and nickel (Ni). For example, the metal magnetic particles 10 and 20 may include at least one of pure iron powder, Fe—Si-based alloy powder, Fe—Si—Al-based alloy powder, Fe—Ni-based alloy powder, Fe—Ni—Mo-based alloy powder, Fe—Ni—Mo—Cu-based alloy powder, Fe—Co-based alloy powder, Fe—Ni—Co-based alloy powder, Fe—Cr-based alloy powder, Fe—Cr—Si alloy powder, Fe—Si—Cu—Nb-based alloy powder, Fe—Ni—Cr-based alloy powder, and Fe—Cr—Al-based alloy powder.

The metal magnetic particles 10 and 20 may be amorphous or crystalline form. For example, the metal magnetic particles 10 and 20 may be Fe—Si—B—Cr-based amorphous alloy powder, but are not limited thereto.

A diameter of the first metal magnetic particle 10 may be about 10 μm to about 50 μm, and a diameter of the second metal magnetic particle 20 may be about 0.1 μm to about 6 μm.

A surface of each of the metal magnetic particles 10 and 20 may be coated with an insulating material. For an example, the surface of each of the metal magnetic particles 10 and 20 may be coated with an organic insulating material including an epoxy resin, polyimide, a liquid crystal polymer, or the like alone or in combination, but is not limited thereto. For another example, the surface of each of the metal magnetic particles 10 and 20 may be coated with an oxide insulating film containing a metal component of the metal magnetic particles 10 and 20 or may be coated with an inorganic insulating material such as SiOₓ, SiNₓ, or phosphate.

At least one of the core portion 110, the upper cover part 120 or the lower cover part 130 includes only the second metal magnetic particle 20, among the first and second metal magnetic particles 10 and 20, as magnetic particles dispersed in the insulating resin R. Specifically, in the case of the present exemplary embodiment, referring to FIGS. 3 and 4, each of the upper cover part 120 and the lower cover part 130 includes both first and second metal magnetic particles as magnetic particles dispersed in the insulating resin R, and the core portion 110 includes only the second metal magnetic particle 20 as magnetic particles dispersed in the insulating resin R.

According to this exemplary embodiment, the core portion 110 includes only the second metal magnetic particle 20 having a relatively small diameter as magnetic particles, and each of the upper cover part 120 and the lower cover part 130 includes both first and second metal magnetic particles 10 and 20 having different diameters from each other. Accordingly, a filling rate of the magnetic particles of each of the upper cover part 120 and the lower cover part 130 may be greater than that of the magnetic particles of the core portion 110. For example, the filling rate of the magnetic particles of the core portion 110 may be 55% to 70%, and the filling rate of the magnetic particles of each of the upper cover part 120 and the lower cover part 130 may be 70% to 85%.

The first metal magnetic particle 10 included in each of the upper cover part 120 and the lower cover part 130 has a relatively larger diameter as compared with the diameter of the second metal magnetic particle 20, and thus exhibits high permeability (relative permeability). In addition, in each of the upper cover part 120 and the lower cover part 130, the filling rate may be improved by mixing the first metal magnetic particle 10 and the second metal magnetic particle 20 as fine powder together, and the relative permeability and a quality (Q) factor may be further improved.

Since the core portion 110 includes only the second metal magnetic particle 20 which is fine powder, the core portion 110 exhibits relatively low permeability than the upper cover part 120 and the lower cover part 130, but since the core portion 110 is formed of a low loss material, it may complement core loss that increases as a high permeability material having a relatively large diameter is used. For example, a difference between the permeability (relative permeability) of the core portion 110 and the upper or lower cover parts 120 and 130 may be 10 to 40.

A thickness T1 of the core portion 110 may be 0.5 to 10 times a thickness T2 of the upper cover part 120 or the lower cover part 130. As the core portion 110 and the upper cover part 120 or the lower cover part 130 satisfy the thickness ratio, inductance and a Q factor may be improved.

The winding coil 200 manifests a characteristic of a coil component. For example, when the coil component 1000 of the present exemplary embodiment is used as a power inductor, the winding coil 200 may serve to stabilize power of an electronic device by storing an electric field as a magnetic field and maintaining an output voltage.

The winding coil 200 is disposed inside the core portion 110 of the body 100, and the first and second lead portions 221 and 222 are exposed to the surface of the body 100. Specifically, the winding coil 200 includes a winding part 210 forming at least one turn around the through core 113 of the body 100 and first and second lead portions 221 and 222 connected to the winding part 210 and exposed to the first and second surfaces 101 and 102 of the body 100, respectively. The winding coil 200 may be formed by winding a metal wire such as copper wire (Cu wire) including a metal wire (MW) and a coating layer IF covering a surface of the metal wire (MW). Accordingly, the entire surface of each of the plurality of turns of the winding coil 200 is covered with the coating layer IF. Meanwhile, the metal wire may be a flat wire, but is not limited thereto. When the winding coil 200 is formed of the flat wire, for example, as shown in FIG. 2, a cross-section of each turn of the winding coil 200 may have a rectangular shape.

The winding part 210 forms an innermost turn, at least one middle turn, and an outermost turn from the through core 113 to an outer side of the body 100 based on the length direction L of the body 100 or the width direction W of the body 100. The winding part 210 may have upper and lower surfaces similar to a ring shape overall and inner and outer surfaces connecting the upper and lower surfaces, so that the winding part 210 may have a cylindrical shape with a cylindrical hollow portion formed at a central portion thereof as a whole. The winding part 210 is an air core coil, and the through core 113 is disposed at an air core of the winding part 210.

The first and second lead portions 221 and 222 are both ends of the winding coil 200 and are exposed to the first and second surfaces 101 and 102 of the body 100, respectively, so as to be spaced apart from each other. The first and second lead portions 221 and 222 may be the remainder of a metal wire such as a copper wire whose surface is covered with the coating layer IF after the winding part 210 is formed. As a result, a boundary may not be formed between the first and second lead portions 221 and 222 and the winding part 210. In addition, like the winding part 210, the coating layer IF is formed on the surface of the first and second lead portions 221 and 222.

The coating layer IF may include, but is not limited to, epoxy, polyimide, liquid crystal polymer, or the like alone or in combination.

The external electrodes 310 and 320 are disposed spaced apart from each other on the body 100 and are connected to the first and second lead portions 221 and 222, which are both ends of the winding coil 200. Specifically, in the case of the present exemplary embodiment, the first external electrode 310 is disposed to cover the first surface 101 of the body 100 and is in contact with and connected to the first lead portion 221 exposed to the first surface 101 of the body 100. In addition, the first external electrode 310 extends to at least a portion of each of the third to sixth surfaces 103, 104, 105, and 106 of the body 100 from the first surface 101. The second external electrode 320 is disposed to cover the second surface 102 of the body 100 and is in contact with and connected to the second lead portion 222 exposed to the second surface 102 of the body 100. In addition, the second external electrode 320 extends to at least a portion of each of the third to sixth surfaces 103, 104, 105, and 106 of the body 100. Meanwhile, the first and second external electrodes 310 and 320 are disposed at opposing ends of the body 100 facing each other in the length direction L on each of the third to sixth surfaces 103, 104, 105, and 106 of the body 100 and are spaced apart from each other.

The external electrodes 310 and 320 may include copper (Cu), aluminum (Al), silver (Ag), tin (Sn), gold (Au), nickel (Ni), lead (Pb), chromium (Cr), titanium (Ti), or an alloy thereof, but is not limited thereto.

The first and second external electrodes 310 and 320 may have a structure including a single layer or a plurality of layers. As an example, the first external electrode 310 may include a first layer including copper (Cu), a second layer disposed on the first layer and including nickel (Ni), and a third layer disposed on the second layer and including tin (Sn). Each of the first to third layers may be formed by electroplating, but are not limited thereto. Each of the first and second external electrodes 310 and 320 may include a conductive resin layer and an electroplating layer. The conductive resin layer may be formed by applying and curing a conductive paste including conductive powder containing silver (Ag) and/or copper (Cu) and an insulating resin such as epoxy.

Meanwhile, although not shown, a surface insulating layer may be formed in regions of the first to sixth surfaces 101, 102, 103, 104, 105, and 106 of the body 100 excluding the regions in which the external electrodes 310 and 320 are disposed. The surface insulating layer may be formed by printing an insulating paste, applying an insulating resin, or stacking an insulating film including an insulating resin on the first to sixth surfaces 101, 102, 103, 104, 105, and 106 of the body 100. The insulating resin may include, but is not limited to, epoxy, polyimide, liquid crystal polymer, or the like alone or in combination.

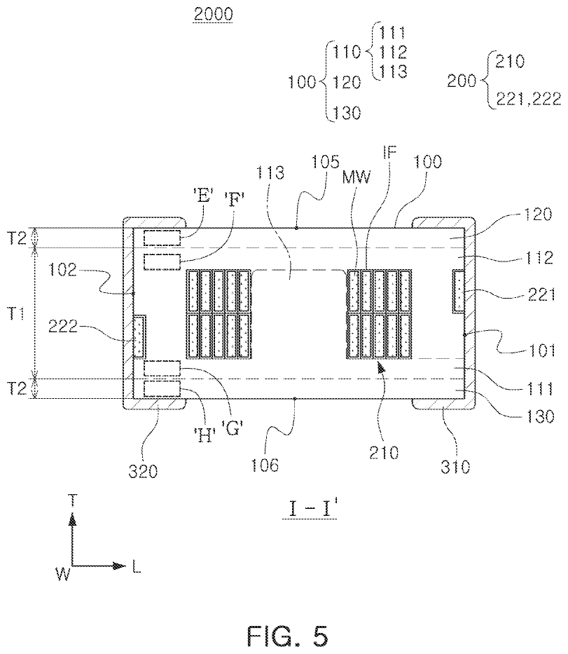

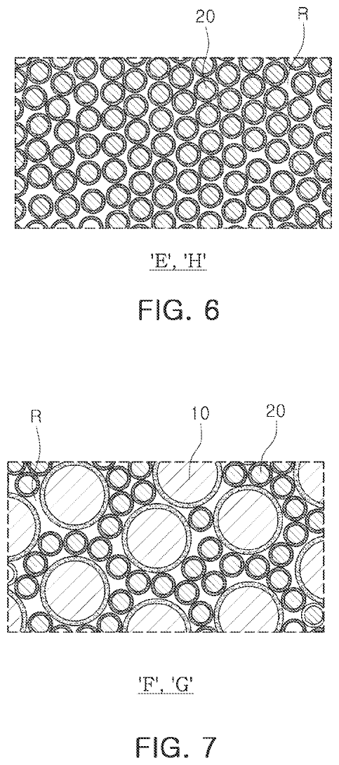

FIG. 5 is a view schematically showing a coil component according to another exemplary embodiment in the present disclosure, corresponding to FIG. 2. FIG. 6 is an enlarged view of each of E and H of FIG. 5. FIG. 7 is an enlarged view of each of F and G of FIG. 5.

Referring to FIGS. 1 to 4 and FIGS. 5 to 7, in a coil component 2000 according to this exemplary embodiment, a distribution of magnetic particles in the body 100 is different from that of the coil component 1000 according to an exemplary embodiment in the present disclosure. Thus, in describing the exemplary embodiment, only the distribution of the magnetic particles in the body 100 different from that of the exemplary embodiment in the present disclosure will be described. For the rest of the configuration of this exemplary embodiment, the description of the exemplary embodiment in the present disclosure may be applied as it is.

Referring to FIG. 5, in the case of the coil component 2000 according to another exemplary embodiment in the present disclosure, a core portion 110 includes both first and second metal magnetic particles 10 and 20 as magnetic particles dispersed in the insulating resin R, and each of the upper cover part 120 and the lower cover part 130 includes only the second metal magnetic particle 20 as magnetic particles dispersed in the insulating resin R. Therefore, a filling rate of the magnetic particles of the core portion 110 may be greater than a filling rate of the magnetic particles of each of the upper cover part 120 and the lower cover part 130. For example, the filling rate of each of the upper cover part 120 and the lower cover part 130 may be 55% to 70%, and the filling rate of magnetic particles of the core portion 110 may be 70% to 85%.

In the case of the present exemplary embodiment, the core portion 110 includes a first metal magnetic particle 10 having a relatively larger diameter as compared with the diameter of the second metal magnetic particle 20. The first metal magnetic particle 10 has a relatively large diameter and may exhibit a high permeability (relative permeability). In addition, the core portion 110 further includes the second metal magnetic particle 20 having a diameter smaller than that of the first metal magnetic particle 10. Since the core portion 110 includes the mixture of the first metal magnetic particle 10 and the second metal magnetic particle 20 as fine powder, a filling rate may be improved to further improve relative permeability and improve a Q factor.

Since each of the upper cover part 120 and the lower cover part 130 includes only the second metal magnetic particle 20 which is fine powder as magnetic particles, each of the upper cover part 120 and the lower cover part 130 exhibits relatively low permeability (relative permeability) compared with the core portion 110, but, since the second metal magnetic particle 20 is a low loss material, the low loss material may complement core loss increased as a high permeability material having a relatively large diameter. For example, a difference in the permeability (relative permeability) between the core portion 110 and the upper or lower cover parts 120 and 130 may be 10 to 40.

In the case of the present exemplary embodiment, the upper cover part 120 and the lower cover part 130 forming the fifth and sixth surfaces 105 and 106 of the body 100 include only the second metal magnetic particle 20 which is fine powder, surface roughness of the fifth and sixth surfaces 105 and 106 of the body 100 may be improved, and problems during plate spreading caused by coarse powder may be improved.

In a case where each of the upper cover part 120 and the lower cover part 130 includes the first metal magnetic particle 10 which is coarse powder, as well as the second metal magnetic particle 20 which is fine powder, the coarse metal magnetic particles may be exposed to the surface of the body 100 and a defect of forming a plating layer in a portion to which the first metal magnetic particle 10 which is coarse powder is exposed during a plating process of forming the external electrodes occurs.

However, in the case of the present exemplary embodiment, the core portion 110 includes the first metal magnetic particle 10 which is coarse powder and each of the upper cover part 120 and the lower cover part 130 includes only the metal magnetic particle 20 which is fine powder to implement high permeability, thereby improving a plating spreading defect, while improving permeability of the entire body 100.

As set forth above, according to exemplary embodiments in the present disclosure, inductance and a Q factor of the winding type coil component may be improved.

While exemplary embodiments have been shown and described above, it will be apparent to those skilled in the art that modifications and variations could be made without departing from the scope of the present disclosure as defined by the appended claims.

What is claimed is:

1. A coil component comprising:
a winding coil;
a body including a core portion covering the winding coil and an upper cover part and a lower cover part respectively disposed on one surface and the other surface of the core portion facing each other; and
first and second external electrodes separately disposed on the body and connected to both ends of the winding coil, respectively,
wherein the body includes an insulating resin, and a magnetic particle dispersed in the insulating layer and including first and second metal magnetic particles having different diameters, and
at least one of the core portion, the upper cover part, and the lower cover part includes only the second metal magnetic particle having a diameter smaller than a diameter of the first metal magnetic particle

2. The coil component of claim 1, wherein
each of the upper cover part and the lower cover part includes first and second metal magnetic particles dispersed in the insulating resin, and
the core portion includes only the second metal magnetic particle dispersed in the insulating resin.

3. The coil component of claim 2, wherein
a relative permeability of each of the upper cover part and the lower cover part is greater than a relative permeability of the core portion.

4. The coil component of claim 2, wherein
a filling rate of the magnetic particles of each of the upper cover part and the lower cover part is greater than a filling rate of the magnetic particles of the core portion.

5. The coil component of claim 1, wherein
the core portion includes both the first and second metal magnetic particles dispersed in the insulating resin, and
each of the upper cover part and the lower cover part includes only the second metal magnetic particle dispersed in the insulating resin.

6. The coil component of claim 5, wherein
a relative permeability of the core portion is greater than a relative permeability of each of the upper cover part and the lower cover part.

7. The coil component of claim 5, wherein
a filling rate of the magnetic particles of the core portion is greater than a filling rate of the magnetic particles of each of the upper cover part and the lower cover part.

8. The coil component of claim 1, wherein
the core portion includes a lower core disposed between the winding coil and the lower cover part, an upper core disposed between the winding coil and the upper cover part, and a through core disposed at a central portion of the winding coil, the lower core and the through core are integrated with each other, and a boundary is formed between the lower core and the upper core and between the through core and the upper core.

9. The coil component of claim 1, wherein
a thickness of the core portion is 0.5 times to 10 times a thickness of the upper cover part or a thickness of the lower cover part.

10. The coil component of claim 1, wherein
the body has one surface and the other surface facing each other and one end surface and the other end surface connecting the one surface and the other surface and facing each other, the first and second external electrodes are disposed to be spaced apart from each other on one surface of the body and extend to the one end surface and the other end surface of the body to be in contact with and connected to both ends of the winding coil exposed to one end surface and the other end surface of the body, respectively.

11. The coil component of claim 4, the filling rate of the magnetic particles of the core portion 110 may be 55% to 70%, and the filling rate of the magnetic particles of each of the upper cover part 120 and the lower cover part 130 may be 70% to 85%.

12. The coil component of claim 7, wherein the filling rate of each of the upper cover part and the lower cover part 130 is 55% to 70%, and the filling rate of magnetic particles of the core portion is 70% to 85%.

13. The coil component of claim 1, wherein a diameter of the first metal magnetic particle is 10 μm to 50 μm, and a diameter of the second metal magnetic particle is 0.1 μm to 6 μm.

14. The coil component of claim 1, wherein the metal magnetic powder particles include at least one selected from the group consisting of iron (Fe), silicon (Si), chromium (Cr), cobalt (Co), molybdenum (Mo), aluminum (Al), niobium (Nb), copper (Cu) and nickel (Ni).
